(19) United States
(12) Patent Application Publication
(10) Pub. No.: US 2007/0083510 A1
(43) Pub. Date: Apr. 12, 2007

(54) Capturing bibliographic attribution information during cut/copy/paste operations

(76) Inventor: James M. McArdle, Austin, TX (US)

Correspondence Address: IBM CORPORATION (SS), C/O STREETS & STEELE, 13831 NORTHWEST FREEWAY, SUITE 355, HOUSTON, TX, 77040, US

(21) Appl. No.: 11/246,582

(22) Filed: Oct. 7, 2005

(51) Int. Cl. G06F 17/30

(52) U.S. Cl. 707/6

(57) ABSTRACT

Capturing bibliographic attributes from an original document by methods, computer program products and systems, including a method comprising marking text in an original document for copying to a manuscript, capturing any identified bibliographic metadata from the original document and capturing a first number of characters starting at the beginning of the original document. Additional steps may include identifying bibliographic metadata in the original document and defining a set of targeted bibliographic attributes to capture from the original document. The method may further include comparing the captured metadata with the set of targeted bibliographic attributes. Such comparison provides for continuing with the step of identifying as missing attributes any of the targeted attributes that were not captured. Other steps may include analyzing the first number of characters to identify bibliographic attributes, extracting the identified bibliographic attributes and inserting the identified bibliographic attributes into a bibliographical section of the manuscript.

### BACKGROUND OF THE INVENTION

1. Field of the Invention

This invention relates to the field of electronic documents and more particularly to the creation and assembly of electronic documents.

2. Description of the Related Art

Documents are increasingly being represented as digital bits of data and stored in electronic databases as electronic documents. These documents often appear as electronic versions of articles, newspapers, magazines, journals, encyclopedias, books, and other printed materials. Such electronic documents are typically comprised of miscellaneous strings of characters, words, sentences, paragraphs, or documents of indeterminate or varied lengths and may include a wide variety of data classifications, such as alphanumerics, symbols, graphics, images, pictures, audio or bit sequences of any sort and combination.

Electronic documents are easily available and accessible by electronic devices and students and researchers now use electronic documents as a major research resource. Suitable electronic devices for accessing this research resource include, for example, computers, personal digital assistants, cell phones and other devices having processors, memory and display capability. These electronic devices may access the electronic documents over the Internet with a browser by downloading them onto a hard drive or other memory media. Alternatively, the electronic devices may access electronic documents that have been stored on memory media, such as CD-ROM, by downloading them from the memory media. Typically, a computer may be used to display the document on a monitor.

Authors and publishers place considerable proprietary value on the textual passages that they generate (e.g., research papers, newspaper and magazine articles). However, the ease in which textual passages can be duplicated in electronic storage media presents the problem that such passages can be copied and/or incorporated into larger documents without proper attribution or remuneration to the original author. This duplication can occur either without modification to the original passage or with only minor revisions such that original authorship cannot reasonably be disputed.

Furthermore, as authors and researchers conduct research to obtain a large quantity of information gathered from other sources, such as through electronic documents, the quantity of the gathered information often becomes so large that the author-researcher becomes overburdened with maintaining the source attribution for some of the gathered information, resulting in an embarrassing accusation of plagiarism after the author's work has been published that includes portions not properly cited to an original work. Even though the plagiarism may have been inadvertent, such accusations of plagiarism may still cause extensive damage through embarrassment, damage to reputation, loss of scholarly credit and financial detriment.

Librarians, researchers, authors and others have recognized the need to embed bibliographic data with electronic documents and there are several standards for providing bibliographic information in a document. Such information is called metadata, which is defined as data about data. Metadata is descriptive information about a digital resource and provides such bibliographic information as, inter alia, authorship, publisher, editor, title, date of publication, date of authorship, file and Website where found.

Metadata can be added to an electronic document upon its creation or it can be added or edited at any time thereafter. Standards for metadata format have been developed and are well known. For example, the Dublin Core Metadata Initiative (DCMI) is an organization dedicated to promoting the widespread adoption of interoperable metadata standards and developing specialized metadata vocabularies for describing resources that enable more intelligent information discovery systems. Extensive information concerning metadata and its use is available on the Website maintained by the DCMI. Additionally, the United States Library of Congress has developed a standard for metadata and further information concerning the use of metadata and the metadata standards of the Library of Congress is available on the Website maintained by the Library of Congress.

Thus, there is a need for methods and systems that improve gathering and adding the proper citations to original works so that originators of the original works are given their proper recognition. Furthermore, there is a need to minimize the risk of inadvertently failing to properly attribute recognition to an original work so that students and researchers are less likely to be embarrassed with an accusation of plagiarism.

### SUMMARY OF THE INVENTION

Embodiments of the present invention include methods, computer program products and systems for bibliographic attribution information. A particular embodiment of a method of the present invention includes the steps of marking text in an original document for copying to a manuscript, capturing any identified bibliographic metadata from the original document and capturing a first number of characters starting at the beginning of the original document. Marking the text in the original document is generally undertaken in response to an instruction from an end user utilizing, for example, a pointer device such as a mouse to indicate the portion of the text to be marked.

The particular embodiment may further include the steps of identifying bibliographic metadata in the original document and defining a set of targeted bibliographic attributes to capture from the original document. The targeted bibliographic attributes may be default attributes or they may be selected or provided by an end user through, for example, a dialogue box. The method may fuirther include the step of comparing the captured metadata with the set of targeted bibliographic attributes. Such comparison provides for the method to continue with the step of identifying as missing attributes any of the targeted attributes that were not captured.

The sources of bibliographic attributes are not only the metadata that may be embedded in the original document or otherwise available as through links to the metadata that are embedded in the original document. Bibliographic attributes may also be identified in the first number of characters that were captured. Particular embodiments of the present invention may further include analyzing the first number of characters to identify the one or more missing elements, capturing the identified missing elements and copying the missing elements into a bibliographic section of the manuscript.

Further, particular embodiments of the present invention may include the steps of analyzing the first number of characters to identify bibliographic attributes, extracting the identified bibliographic attributes and inserting the identified bibliographic attributes into a bibliographical section of the manuscript.

Embodiments of the present invention provide an opportunity for an end user to review the captured and/or analyzed and extracted bibliographic attributes and correct and/or add additional information to complete the bibliographic attributes. Particular embodiments of the present invention may further include the steps of displaying any captured bibliographic metadata, displaying the first number of characters and modifying the bibliographic attributes in response to a user input, wherein the user provides the user input to correct the displayed metadata. Further steps may include querying an end user for additional or correct bibliographic attributes and executing instructions received in response to the query to provide additional bibliographic attributes or to correct displayed bibliographic attributes.

Embodiments of the present invention further include computer program products. In one embodiment, the computer program product comprises a computer useable medium having computer usable code for capturing bibliographic attribution information, the computer program product comprising computer useable program code for marking text in an original document for copying to a manuscript, computer useable program code for capturing any identified bibliographic metadata from the original document and computer useable program code for capturing a first number of characters starting at the beginning of the original document.

Embodiments of the present invention fiirther include systems for capturing bibliographic attribution information. In one particular embodiment, a system of the present invention comprises one or more processors coupled to one or more memory devices and input/output devices coupled to the system, wherein the input/output devices include a display and a first file loaded into the one or more memory devices comprising an original document having characters, bibliographic metadata and combinations thereof. The system further includes an attribute editor having a logical structure to provide instructions to the one or more processors for capturing identified bibliographic metadata from the original document and capturing a first number of the characters starting at the beginning of the original document. The attribute editor further provides instructions to the one or more processors for comparing the captured metadata with a set of targeted bibliographic attributes and identifying as missing attributes any of the targeted attributes that were not captured.

The foregoing and other objects, features and advantages of the invention will be apparent from the following more particular description of a preferred embodiment of the invention, as illustrated in the accompanying drawing wherein like reference numbers represent like parts of the invention.

### BRIEF DESCRIPTION OF THE DRAWINGS

FIG. 1 is a schematic diagram of a system that is suitable for capturing bibliographic information from an original electronic document.

FIG. 2 is a flow diagram for capturing metadata and a first set of characters from an electronic original document.

FIGS. 3 is a flow diagram for processing the captured metadata and set of characters from FIG. 2.

FIG. 4 is a flow diagram for further processing the set of characters processed in FIG. 3.

### DETAILED DESCRIPTION OF PREFERRED EMBODIMENTS

Embodiments of the present invention include methods, computer program products and systems that are useful for capturing bibliographic attribution information concerning electronic documents, databases, Websites and other similar original documents containing information in electronic form. The embodiments may be useful, for example, to students and researchers using electronic documents for research and who extract portions of these electronic documents for inclusion in their own manuscripts. Extraction operations include, for example, the cut, copy and paste operations that are widely used in word processors, browsers and other computer software designed for assembling, writing, editing or compiling documents. In particular embodiments of the present invention, an end user who downloads or otherwise receives an original electronic document can extract portions of the electronic document along with the bibliographic information related to the extracted portion.

In one embodiment of the present invention, a method is provided that includes the steps of marking an original document for copying to a manuscript. The copy operation is an extraction operation that allows the end user to copy the marked text, for example, to a clipboard, and then paste the marked text from the clipboard into a manuscript being assembled by the end user. Alternatively, the marked material could be copied to another memory medium, such as a CD-ROM or other computer readable memory, and later copied to the manuscript.

The embodiment further includes the step of capturing any identified bibliographic metadata from the original document. Some of the electronic documents used for research by the end user may include metadata that provides the bibliographic attributes for the original document. If the metadata is embedded in the original document in an identifiable format, then the metadata is captured from the original document, preferably for use as bibliographic information.

As known to those having ordinary skill in the art, metadata may be embedded in a document using several standards for metadata including, for example, the standard of the Dublin Core Metadata initiative. The following is one example of metadata in a form that may be included in a document:

```
<HEAD profile=“http://www.widgetsinc.com/profiles/core”>
  <TITLE>How to produce widget cover sheets</TITLE>
  <META name=“author” content=“John Doe”>
  <META name=“copyright” content=“&amp;copy; 2005 Widgets, Inc.”>
  <META name=“date” content=“2005-02-06T08:49:37+00:00”>
  </HEAD>
```

In this example, the following metadata is provided: the title of the document is provided, the authors name is provided, a copyright notice is provided and the date the document was produced is provided. All of this metadata, plus any additional metadata that an author would like to provide, may be included with the original document.

It should be noted that for documents produced using Hyper Text Markup Language (HTML), an authoring language used to create documents, some HTML elements and attributes already handle certain pieces of metadata and may be used by authors instead of or in addition to one of the different standards available for inclusion of metadata. Examples of metadata already included in HTML language include, for example, the “Title” element, the “Address” element, the “title” attribute, and the “cite” attribute.

Furthermore, the method of the particular embodiment may further include the step of capturing a first number of characters starting at the beginning of the original document. Most documents include bibliographical data at the beginning of the document. For example, a title page of an electronic document may include the title, author, publisher, date of publication, date of origination, volume, edition, other similar information or combinations thereof. Even if there is no title page, the first portion of a document typically provides the title, author and date of publication. Whether there is identifiable metadata that may be captured or not, by capturing the first number of characters starting at the beginning of the original document provides a likely chance that at least some of the desired bibliographic attributes will be captured.

The first number of characters that are captured may be any suitable number likely to capture relevant bibliographic attributes. For example, without limiting the invention, capturing a first number of characters that is less than about 2000 is typically sufficient. Preferably, a first number of characters may be captured from between about 800 to about 1500 characters. If the first number of characters is not a sufficient number, then a second and greater number of characters may be extracted starting from the beginning of the original document.

Particular embodiments of the present invention may further include defining a set of desired bibliographic attributes that are targeted for capture from the original document. For example, an end user may designate those bibliographic attributes that are desired to be captured and indicate those attributes through, for example, a check list on a dialogue box. Alternatively, the targeted bibliographic attributes may be designated by a set of default selections. Optionally, the targeted bibliographic attributes may be based upon the type of document or material being copied from the original document. As known, the type of document may be specified as a metadata and therefore, available for discovery.

If particular bibliographic attributes are targeted for being captured from the original document, particular embodiments of the invention may include the step of comparing the identified bibliographic attributes that are captured with the targeted attributes and identifying as missing attributes any of the targeted attributes that were not captured. These missing attributes could then be displayed to an end user, as through a dialogue box, and the method may include the step of querying the end user for the missing attributes. The end user may then, for example, provide the missing attributes to complete the bibliographic attribute acquisitions.

Particular embodiments of the present invention include capturing bibliographic attributes by identifying and reading metadata that is embedded in the original electronic document or is otherwise available as, for example, through links embedded and identified as links to metadata within the documents. As a further step, particular embodiments may include capturing the first number of characters starting at the beginning of the original document. It is more difficult to capture the bibliographic attributes from the first number of characters because these characters are not in a form recognized as a metadata field but are instead in a natural language form. Therefore, these characters may be analyzed to determine if they contain targeted bibliographic data.

Particular embodiments of the present invention may therefore include a step of analyzing the captured characters to identify targeted bibliographic attributes. Analyzing natural language and extracting information from the natural language may include, for example, searching for a specific word or a specific format of the characters and then extracting that information as bibliographic information. For example, when analyzing the number of characters in an attempt to capture the title of the original document, the method may first look for the words “title” and “subtitle” and copy any characters that occur thereafter. Additionally, the analysis may include identifying italicized or underlined characters as being the title of the document. Dates can be determined by looking for a format, such as dd/mm/yyyy or dd-mm-yyyy or by searching for the month by name. Techniques for parsing and for information extraction from original documents are known to those having ordinary skill in the art and are useful for analyzing the captured characters from the start of the original document to identify and capture the desired and targeted bibliographic attributes.

Another option for determining the bibliographic attributes that are contained in the captured number of characters is to display the captured characters to the end user and query the end user whether there are any bibliographic attributes contained within the captured characters. If there are, then the end user can, for example, identify them by marking portions of the captured characters that are attributes and indicating the type of attribute, such as author or title. Alternatively, the end user may answer a query as to the author, title or other targeted attributes, which the end user may answer by reading and marking the captured characters or answering the query in a dialogue box using a keyboard to type in the answers.

The bibliographical attributes related to the original document, whether they are, for example, captured as metadata, captured after analyzing the captured characters starting from the beginning of the document, identified by an end user in answer to a query or marked or otherwise identified by an end user, the bibliographical attributes may be copied into a bibliographic section of the manuscript being assembled by the end user. In particular embodiments of the present invention, the marked text of the original document is copied and inserted into the manuscript. Along with the inserted marked text, the captured or identified bibliographic attributes are copied to a bibliographic section of the manuscript. The association between the attributes and the copied text is maintained even if the text is moved to another location within the manuscript.

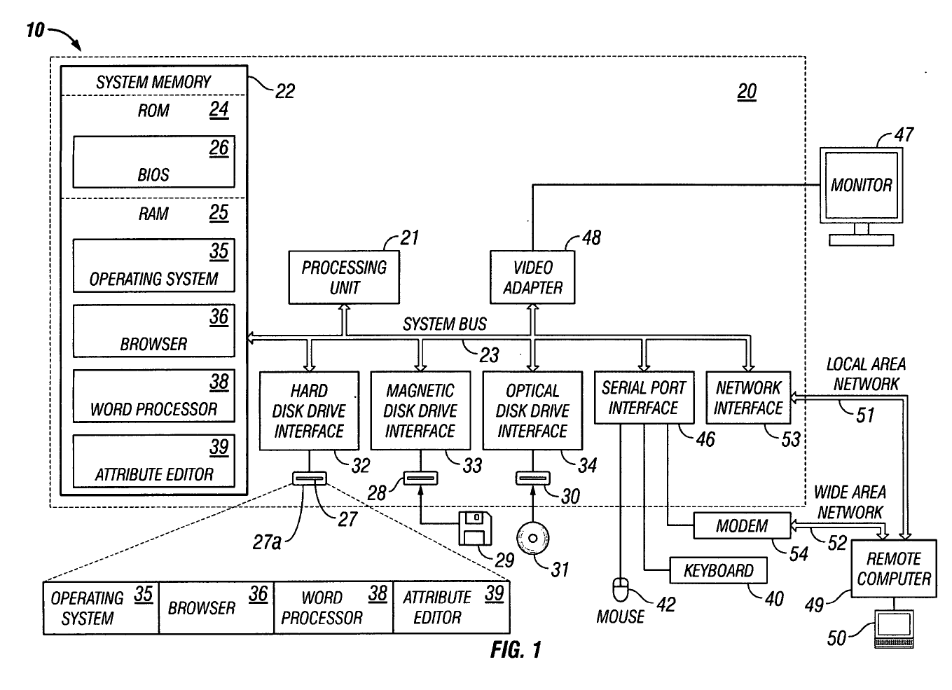

FIG. 1 is a schematic diagram of a system that is suitable for capturing bibliographic information from an original electronic document. The system 10 includes a general-purpose computing device in the form of a conventional personal computer 20. Generally, a personal computer 20 includes a processing unit 21, a system memory 22, and a system bus 23 that couples various system components including the system memory 22 to processing unit 21. System bus 23 may be any of several types of bus structures including a memory bus or memory controller, a peripheral bus, and a local bus using any of a variety of bus architectures. The system memory includes a read only memory (ROM) 24 and random access memory (RAM) 25. A basic input/output system (BIOS) 26, containing the basic routines that help to transfer information between elements within the personal computer 20, such as during start-up, is stored in ROM 24.

The personal computer 20 further includes a hard disk drive 27a for reading from and writing to a hard disk 27, a magnetic disk drive 28 for reading from or writing to a removable magnetic disk 29, and an optical disk drive 30 for reading from or writing to a removable optical disk 31 such as a CD-ROM or other optical media. Hard disk drive 27a, magnetic disk drive 28, and optical disk drive 30 are connected to system bus 23 by a hard disk drive interface 32, a magnetic disk drive interface 33, and an optical disk drive interface 34, respectively. Although the exemplary environment described herein employs hard disk 27, removable magnetic disk 29, and removable optical disk 31, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment. The drives and their associated computer readable media provide nonvolatile storage of computer-executable instructions, data structures, program modules, and other data for the personal computer 20. For example, one or more data files 60 may be stored in the RAM 25 and/or hard disk 27 of the personal computer 20.

A user may enter commands and information into personal computer 20 through input devices, such as a keyboard 40 and a pointing device 42. Other input devices (not shown) may include a microphone, joystick, game pad, satellite dish, scanner, or the like. These and other input devices are often connected to processing unit 22 through a serial port interface 46 that is coupled to the system bus 23, but may be connected by other interfaces, such as a parallel port, game port, a universal serial bus (USB), or the like. A display device 47 may also be connected to system bus 23 via an interface, such as a video adapter 48. In addition to the monitor, personal computers typically include other peripheral output devices (not shown), such as speakers and printers.

The personal computer 20 may operate in a networked environment using logical connections to one or more remote computers 49. Remote computer 49 may be another personal computer, a server, a client, a router, a network PC, a peer device, a main frame, a personal digital assistant, an Internet-connected mobile telephone or other common network node. While a remote computer 49 typically includes many or all of the elements described above relative to the personal computer 20, only a memory storage device 50 has been illustrated in the figure. The logical connections depicted in the figure include a local area network (LAN) 51 and a wide area network (WAN) 52. Such networking environments are commonplace in offices, enterprise-wide computer networks, intranets, and the Internet.

When used in a LAN networking environment, the personal computer 20 is often connected to the local area network 51 through a network interface or adapter 53. When used in a WAN networking environment, the personal computer 20 typically includes a modem 54 or other means for establishing communications over WAN 52, such as the Internet. Modem 54, which may be internal or external, is connected to system bus 23 via serial port interface 46. In a networked environment, program modules depicted relative to personal computer 20, or portions thereof, may be stored in the remote memory storage device 50. It will be appreciated that the network connections shown are exemplary and other means of establishing a communications link between the computers may be used.

A number of program modules may be stored on hard disk 27, magnetic disk 29, optical disk 31, ROM 24, or RAM 25, including an operating system 35, a browser 36, a document 38, and an attribute editor 39. Program modules include routines, sub-routines, programs, objects, components, data structures, etc., which perform particular tasks or implement particular abstract data types. Aspects of the present invention may be implemented in the form of an attribute editor 39 that can be incorporated into or otherwise in communication with a browser program module 36 or with a word processor 38. The browser program module 36 generally comprises computer-executable instructions for displaying, inter alia, HTML documents. The word processor 38 also generally comprises computer-executable instructions that can also display and assemble documents, including manuscripts. The attribute editor 39 generally comprises computer-executable instructions for capturing, formatting, inserting, associating, obtaining and controlling bibliographic attributes associated with an electronic document and a manuscript.

The described example shown in FIG. 1 does not imply architectural limitations. For example, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

It should be recognized therefore, that embodiments of the present invention may take the form of an entirely hardware embodiment, an entirely software embodiment or an embodiment containing both hardware and software elements. In particular embodiments, including those embodiments of methods, the invention may be implemented in software, which includes but is not limited to firmware, resident software and microcode.

Furthermore, the invention can take the form of a computer program product accessible from a computer-readable medium providing program code for use by or in connection with a computer or any instruction execution system. For the purposes of this description, a computer-usable or computer readable medium can be any apparatus that can contain, store, communicate, propagate or transport the program for use by or in connection with the instruction execution system, apparatus or device.

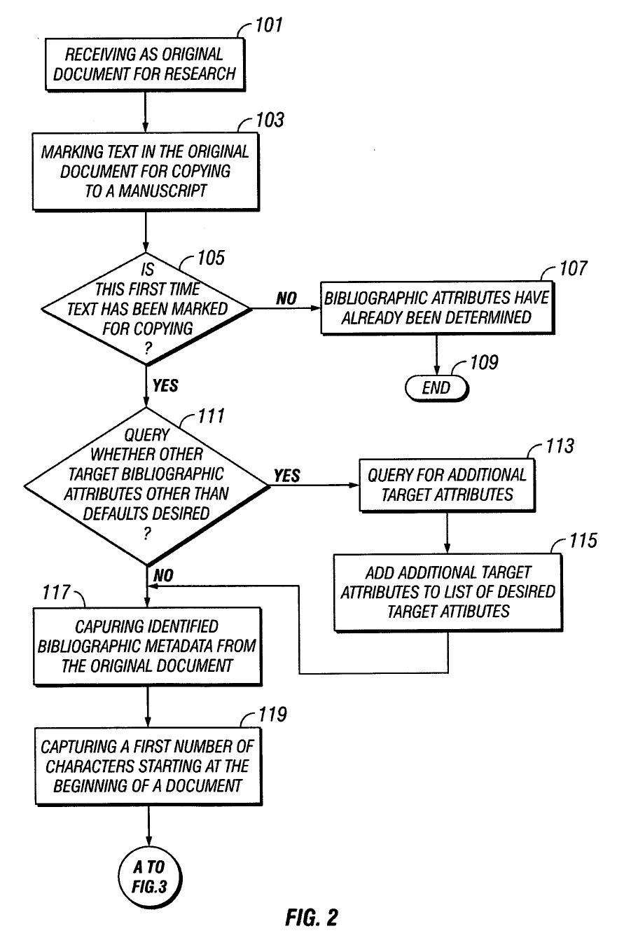

FIG. 2 is a flow diagram for capturing metadata and a first set of characters from an electronic original document. While inventive embodiments of methods are demonstrated in this and the following flow charts, it should be realized that the demonstrated methods may be implemented using computer code and/or a suitable system. In state 101, the exemplary method includes receiving an original document that will be used by an end user to obtain information relevant, for example, to the end user's research or study and used in assembling a manuscript. In state 103, text is marked in the original document for copying to the manuscript. If, in state 105, it is determined that the text marking is not the first time text has been marked and copied, then in state 107, the bibliographic attributes of the original document have already been determined and in state 109, the method ends.

If, in state 105, it is determined that the is the first time text has been marked for copying to a manuscript, then in state 111, the end user is queried as to whether there are additional target bibliographic attributes to be captured other than default attributes. If, in state 111, it is determined that there are additional target attributes to be captured, then in state 113, the end user is queried for the additional target attributes and in state 115, the additional attributes supplied by the end user are added to the list of the target attributes that are to be captured.

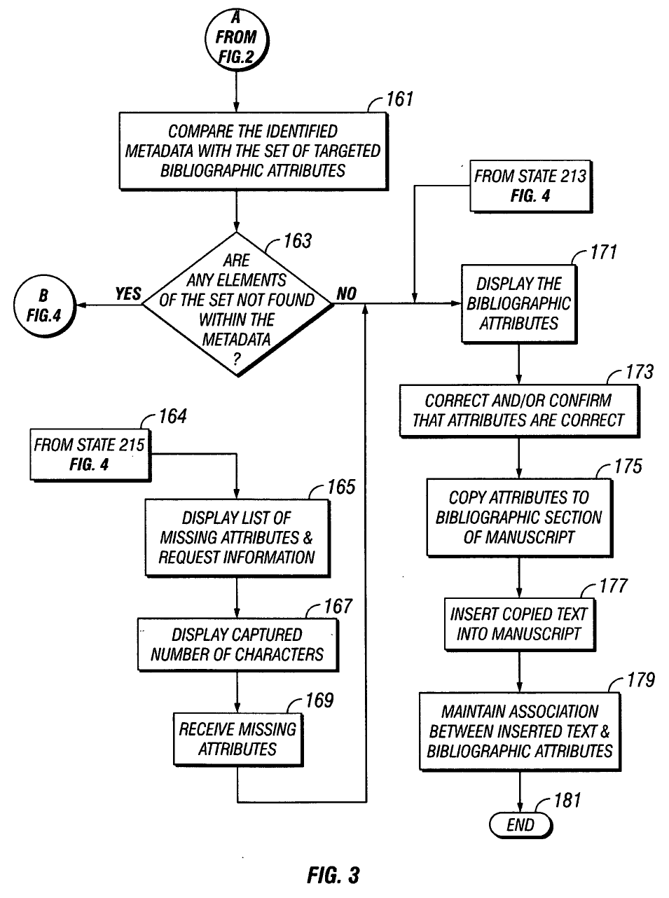

If, in state 111, it is determined that the default attributes will be the only attributes targeted, and further continuing from state 115, in state 117, the exemplary method includes capturing identified bibliographic metadata from the original document and in state 119, capturing a first number of characters starting at the beginning of the original document. The exemplary method then continues to branch A of FIG. 3.

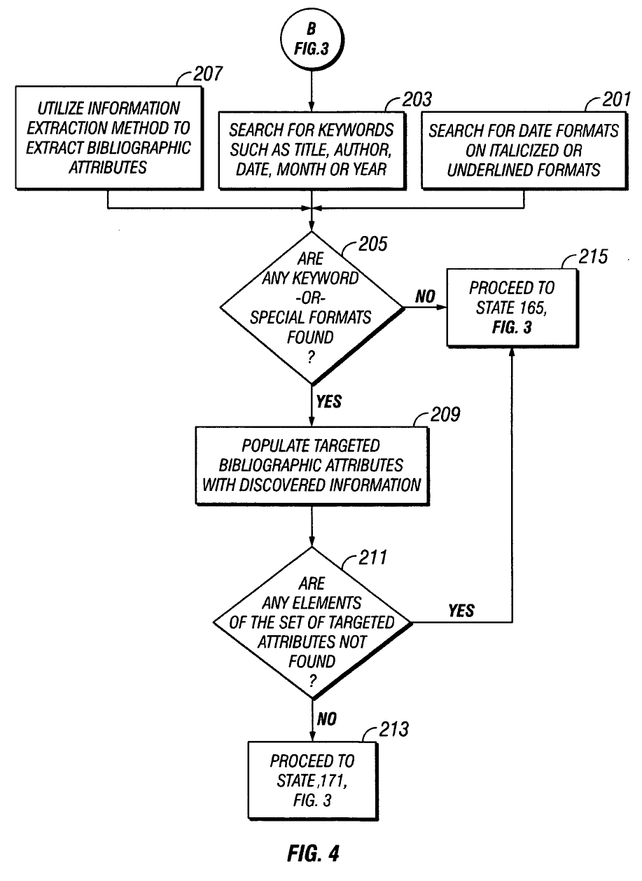

FIG. 3 is a flow diagram for processing bibliographic attributes captured from an original document. In state 161, the exemplary method compares the identified metadata with the set of targeted metadata. If, in state 163, there are elements of the set of targeted metadata not found within the captured metadata, the method proceeds to FIG. 4 to examine the captured number of characters for bibliographic attributes in an exemplary method described below. In state 164, the method described in FIG. 4 returns with elements of the targeted bibliographic attributes not found from the captured number of characters and then in state 165, the missing elements are displayed as a list to inform the end user of the missing targeted bibliographic attributes. In state 167, the captured number of characters is displayed so that an end user can review the captured number of characters. In state 169, the missing bibliographic attributes are received from the end user; These attributes may be received by an end user inputting the missing attributes through, for example, a dialogue box that displays the missing attributes and provides an area for the end user to input, by using a keyboard for example, the missing information after reviewing the captured number of characters that are displayed. The method then continues to state 171. Furthermore, if, in state 163, there are no elements of the set that are missing, then the exemplary method also proceeds to state 171.

In state 171, the bibliographic attributes are displayed in, for example, a dialogue box. After an end user reviews and approves the bibliographic data as being correct and fully assembled, in state 173, the exemplary method receives confirmation that the displayed bibliographic attributes are correct and optionally, that none of the set of targeted bibliographic attributes are missing. The end user may also provide any missing bibliographic attributes or correct any of the displayed bibliographic attributes at this point as necessary.

In state 175, the bibliographic attributes are copied to a bibliographic section of the manuscript and in state 177, the copied text is inserted into the manuscript. In state 179, the exemplary method includes the step of maintaining an association between the inserted text and the bibliographic attributes so that if the text is removed from the manuscript or is moved within the manuscript, the association between the inserted text and the bibliographic attributes is maintained. In state 181, the exemplary method ends.

FIG. 4 is a flow diagram for analyzing the set of characters captured in FIG. 2. The captured characters can be analyzed to determine if they contain any bibliographic attributes. Continuing from Branch B of FIG. 3, in state 203, the exemplary method includes the step of searching for keywords that provide a signpost for targeted bibliographic attributes. Such keywords may include, for example, author, title and published. In state 201, the exemplary method includes the step of searching for date formats, italicized or underlined formats that may be indicative of bibliographic attributes. In state 207, the exemplary method includes utilizing information extraction methods to extract bibliographic attributes from the captured characters. From each of states 201, 203 and 207, the method continues to state 205. If, in state 205, the preceding states found special formats, keywords or extracted attributes, then in state 209, the information is matched with the targeted bibliographic attributes so that each of the targeted bibliographic attributes are populated with the discovered information. In state 211, if there are no elements of the set of targeted attributes not found, then in state 213, the method continues to state 171 of FIG. 3 as previously discussed. If, in state 211, there are elements that have not been found or if in state 205, there were no key words or special formats found, then in state 215, the method continues to state 165 of FIG. 3 as previously discussed.

It should be understood from the foregoing description that various modifications and changes may be made in the preferred embodiments of the present invention without departing from its true spirit. The foregoing description is provided for the purpose of illustration only and should not be construed in a limiting sense. Only the language of the following claims should limit the scope of this invention.

What is claimed is:

1. A method for capturing bibliographic attribution information, comprising the steps of:
marking text in an original document for copying to a manuscript;
capturing any identified bibliographic metadata from the original document; and
capturing a first number of characters starting at the beginning of the original document.

2. The method of claim 1, further comprising:
identifying bibliographic metadata in the original document;
defining a set of targeted bibliographic attributes to capture from the original document;
comparing the captured identified metadata with the set of targeted bibliographic attributes; and
identifying as missing attributes any of the targeted attributes that were not captured.

3. The method of claim 2, further comprising:
analyzing the first number of characters to identify the one or more missing attributes;
capturing the identified missing attributes; and
copying the missing attributes and the captured identified metadata into a bibliographic section of the manuscript.

4. The method of claim 1, wherein the first number of characters is less than about 2000.

5. The method of claim 1, further comprising:
inserting the marked text into the manuscript; and
inserting the captured bibliographic metadata into a bibliographic section of the manuscript.

6. The method of claim 1, further comprising:
analyzing the first number of characters to identify bibliographic attributes;
extracting the identified bibliographic attributes; and
inserting the identified bibliographic attributes into a bibliographical section of the manuscript.

7. The method of claim 6, further comprising:
displaying any captured bibliographic metadata;
displaying the first number of characters; and
modifying the bibliographic attributes in response to a user input, wherein the user provides the user input to correct the displayed metadata.

8. The method of claim 7, further comprising:
querying an end user for additional or correct bibliographic attributes; and
executing instructions received in response to the query to provide additional bibliographic attributes or to correct displayed bibliographic attributes.

9. A computer program product comprising a computer useable medium having computer usable code for capturing bibliographic attribution information, the computer program product comprising:
computer useable program code for marking text in an original document for copying to a manuscript;
computer useable program code for capturing any identified bibliographic metadata from the original document; and
computer useable program code for capturing a first number of characters starting at the beginning of the original document.

10. The computer program product of claim 9, further comprising:
computer useable program code for identifying bibliographic metadata in the original document;
computer useable program code for defining a set of targeted bibliographic attributes to capture from the original document;
computer useable program code for comparing the captured metadata with the set of targeted bibliographic attributes; and
computer useable program code for identifying as missing attributes any of the targeted attributes that were not captured.

11. The computer program product of claim 10, further comprising:
computer useable program code for analyzing the first number of characters to identify the one or more missing elements;
computer useable program code for capturing the identified missing elements; and
computer useable program code for copying the missing elements into a bibliographic section of the manuscript.

12. The computer program product of claim 9, wherein the first number of characters is less than about 2000.

13. The computer program product of claim 9, further comprising:
computer useable program code for inserting the marked text into the manuscript; and
computer useable program code for inserting the captured bibliographic metadata into a bibliographic section of the manuscript.

14. The computer program product of claim 9, further comprising:
computer useable program code for analyzing the first number of characters to identify bibliographic attributes;
computer useable program code for extracting the identified bibliographic attributes; and
computer useable program code for inserting the identified bibliographic attributes into a bibliographical section of the manuscript.

15. The computer program product of claim 14, further comprising:
computer useable program code for displaying any captured bibliographic metadata;
computer useable program code for displaying the first number of characters; and
computer useable program code for modifying the bibliographic attributes in response to a user input, wherein the user provides the user input to correct the displayed metadata.

16. The computer program product of claim 15, further comprising:
computer useable program code for querying an end user for additional or correct bibliographic attributes; and
computer useable program code for executing instructions received in response to the query to provide additional bibliographic attributes or to correct displayed bibliographic attributes.

17. A system for capturing bibliographic attribution information, comprising:
one or more processors coupled to one or more memory devices and input/output devices, wherein the input/output devices include a display;
a first file loaded into the one or more memory devices comprising an original document having characters, bibliographic metadata and combinations thereof;
an attribute editor having a logical structure to provide instructions to the one or more processors for capturing identified bibliographic metadata from the original document and capturing a first number of the characters starting at the beginning of the original document; and
the attribute editor further providing instructions to the one or more processors for comparing the captured metadata with a set of targeted bibliographic attributes and identifying as missing attributes any of the targeted attributes that were not captured.

18. The system of claim 17, further comprising:
a second file loaded into the one or more memory devices comprising a manuscript having a composition portion and a bibliographic portion; and
the attribute editor further providing instructions to the one or more processors for analyzing the first number of characters to identify the one or more missing elements, capturing the identified missing elements and copying the missing elements into a bibliographic section of the manuscript.

19. The system of claim 18, further comprising:
the attribute editor further providing instructions to the one or more processors for analyzing the first number of characters to identify bibliographic attributes, extracting the identified bibliographic attributes and inserting the identified bibliographic attributes into a bibliographical section of the manuscript; and
a user interface coupled in communication with the one or more processors to communicate a request to insert marked text copied from the original document into the manuscript.

20. The system of claim 19, further comprising:
the attribute editor further providing instructions to the one or more processors for displaying any captured bibliographic metadata and displaying the first number of characters; and
the user interface coupled in communication with the one or more processors flurther for communicating input from an end user to correct the displayed metadata.
